(19) United States
(12) Patent Application Publication
(10) Pub. No.: US 2016/0276705 A1
(43) Pub. Date: Sep. 22, 2016

(54) RECHARGEABLE ELECTROCHEMICAL LITHIUM CELL WITH SULFUR DIOXIDE-CONTAINING ELECTROLYTE

(71) Applicant: FORTU NEW BATTERY TECHNOLOGY GMBH, Bonn (DE)

(72) Inventor: Günther Hambitzer, Bonn (DE)

(21) Appl. No.: 15/035,887

(22) PCT Filed: Nov. 10, 2014
(86) PCT No.: PCT/EP2014/074145

§ 371 Date: May 11, 2016

(30) Foreign Application Priority Data
Nov. 11, 2013 (DE) 10 2013 112 385.6

(51) Int. Cl. H01M 10/0563; H01M 4/62; H01M 10/0525; H01M 4/36; H01M 4/58; H01M 4/133

(52) U.S. Cl. CPC H01M 10/0563; H01M 4/5815; H01M 4/133; H01M 10/0525; H01M 4/366; H01M 4/625; H01M 2004/021

(57) ABSTRACT

The invention relates to a rechargeable, non-aqueous electrochemical battery cell which has a negative electrode, a positive electrode and a sulfur dioxide-containing electrolyte.

The invention relates to a non-aqueous rechargeable electrochemical battery cell with a positive electrode, a negative electrode and an electrolyte.

Rechargeable battery cells are of major importance in many technical fields. In many cases they are used for mobile applications, such as for example mobile telephones, notebooks and electric vehicles.

A requirement of rechargeable batteries is, inter alia, a high specific energy or a high energy density. The cell should contain as much electrical energy as possible per unit of weight and volume. In this respect lithium is particularly advantageous as an active cation or active metal.

In addition, there is a great need for battery cells for stationary applications, such as grid stabilization, grid buffering and decentralized power supply. In this case, in particular at high energy efficiency, a high number of cycles with low production costs is advantageous. The present invention is directed to cells for both mobile and also stationary applications.

In practice rechargeable cells are currently predominantly lithium ion cells. The negative electrode thereof consists of copper coated with carbon, into which lithium ions are incorporated during charging. Also the positive electrode consists of an insertion material which is suitable to receive ions of the active metal. In conventional battery cells the positive electrode can be based on lithium cobalt oxide which is applied to a discharge element made of aluminum. Both electrodes are very thin (thickness generally less than 100 μm). During charging the ions of the active metal are removed from the positive electrode and incorporated into the negative electrode. During discharge the process operates in reverse. The transport of the ions between the electrodes takes place by means of the electrolyte, which ensures the necessary ion mobility. Conventional lithium ion cells contain an electrolyte, which in conventional cells consists of a lithium salt (for example LiPF₆) dissolved in an organic solvent or solvent mixture (for example based on ethylene carbonate). They are also designated below as “organic lithium ion cells”.

In normal operation lithium ion cells do not contain any accumulations of metallic lithium. Organic lithium ion cells pose problems with regard to safety. Safety risks are caused in particular by the organic electrolyte. If, for example, because of a product defect or a production fault or overcharging with metallic lithium deposition, a lithium ion cell catches fire or even explodes, the organic solvent of the electrolyte in combination with different active materials forms the combustible mixture. In order to avoid such risks, additional measures must be employed, in particular with regard to a very exact control of the charging and discharging processes and with regard to additional safety measure in the battery design. These measures are all the more elaborate the greater the capacity of the cell and the risk of danger are. Thus they lead to increased costs and additionally they considerably increase the volume and weight and reduce the energy density.

There is a substantial need for improved rechargeable battery cells which in particular meet the following requirements:
Safety, even under difficult environmental conditions, such as in a vehicle.
Very good electrical output data, in particular high energy density with simultaneously high available currents, that is to say high power density.
Substantial service life, in particular a large number of usable charging and discharging cycles.
Lowest possible price, i.e. cost-effective materials and simplest possible production methods.

A further important requirement for use in practice is, for example, the deep discharge capacity.

Thus, especially for a high number of cells which are serially connected to batteries, a discharge capacity of each individual cell to 0 V is desirable. In practice this is not possible with the current organic lithium ion cells, since these are irreversibly damaged in the event of discharging below 2.7 V.

The object of the invention is to solve the technical problem and to provide a battery cell which meets these sometimes contradictory requirements—viewed overall—better than in the past.

The invention relates in particular to a battery cell in which the active cations, which react during charging of the battery cell on the negative electrode by incorporation into a host lattice or by alloy formation or by deposition as metal, originate from the alkali metal group, alkaline earth metal group or from the second sub-group of the periodic system. Lithium is particularly preferred. Metal dithionites can also be formed from the groups of these cations, if they are not electronically conductive. Reference is made below, without limiting the generality, to lithium as cation, which reacts on the negative electrode.

The electrolyte used within the scope of the invention contains sulfur dioxide (SO2). Within the scope of the invention an electrolyte which not only contains SO2 or reaction products of SO2 as an addition in a small concentration, but also in which the mobility of the ions which effect transport of the charge is ensured at least partially by the SO2 or by the reaction products of the SO2, is designated as a “SO2-containing electrolyte”. In the case of the active cations from the group of alkali metals, tetrahalogenoaluminate is preferably used as an anion of the conducting salt. Lithiumtetrachloroaluminate is preferably used as conducting salt for the active lithium cation. Lithium cells with a SO2-containing electrolyte are designated below as Li—SO2 cells.

Furthermore, the invention also relates to battery cells which also contain other electrolytes in addition to sulfur dioxide or substances produced by reaction with sulfur dioxide. These electrolytes may contain other conducting salts (for example halides, oxalates, borates, phosphates, arsenates, gallates) and other solvents which ensure the mobility of the ions. In this case these solvents may be inorganic solvents, organic solvents or ionic liquids or mixtures thereof. Saturated hydrocarbons preferably also come into consideration as organic solvent.

The electrolyte is preferably substantially free of organic materials, wherein “substantially” may be understood to mean that the quantity of organic materials potentially present is so small that they do not represent a significant safety risk, for example with regard to combustibility.

A preferred embodiment of the invention relates to a rechargeable battery cell with a negative electrode, an electrolyte and a positive electrode with a porous structure for storing active metal which results the deposition of the active cations during charging of the cell.

The technical problem is solved by an electrochemical rechargeable lithium battery cell with a housing, a positive electrode, a negative electrode and an electrolyte which contains a conducting salt wherein the electrolyte is SO2-containing.

In a first aspect the invention relates to a rechargeable electrochemical battery cell with an intraporous separator layer.

In WO 2008/058685 a rechargeable electrochemical battery cell with a negative electrode, an electrolyte and a positive electrode is described. The negative electrode has an electronically conductive substrate, on which an active metal of the negative electrode is deposited electrolytically during charging of the cell. A porous structure which contains the active material of the positive electrode is arranged in the vicinity of the substrate of the negative electrode in such a way that the active metal deposited during charging of the cell penetrates into the pores of the porous structure containing the active material of the positive electrode and is further deposited there, at least partially, in metallic form.

A component of the cell, which changes its state of charge in the redox reaction taking place on the positive electrode, is designated as an active material of the positive electrode.

A basic principle of battery technology is that the active metal of the negative electrode and the active material of the positive electrode are separated from one another in such a way that no electronic conduction is possible between them within the cell because the functioning of the cell is impaired as a result. The flow of electrons corresponding to the redox reactions of the two active materials and the flow of ions between the active materials should be conducted via the respective electronically conductive discharge elements to the connection contacts outside the cell. An electronic short-circuit between the active materials leads to charge losses and by means of heat production in the extreme case leads to safety problems.

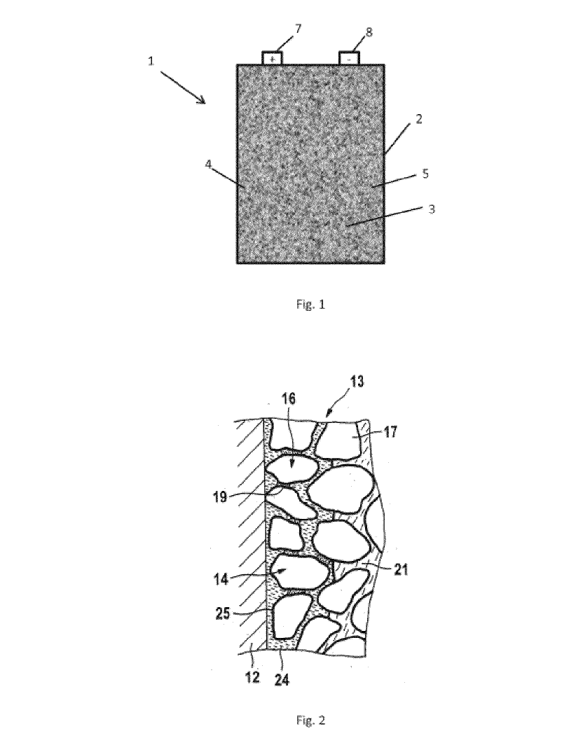

FIG. 1 shows a general diagram of a rechargeable battery 1 with a housing 2 and at least one battery cell 3 which has a positive electrode 4 and a negative electrode 5. In this case by means of discharge elements the electrodes 4, 5 are optionally connected via electrode connections, which are customary in battery technology, to connection contacts 7, 8 by means of which the battery can ultimately be charged or discharged.

FIG. 2 shows a schematic detail, not to scale, of an electrode arrangement which makes clear the penetration of the deposited active metal in pores of the porous structure.

Because of the substantial ionic conductivity of the SO2-containing electrolyte—the conductivity is generally at least ten times higher than that of organic electrolytes—, with the same electrical power output in battery cells with a SO2-containing electrolyte substantially thicker positive and negative electrodes can be used than in conventional cells with organic electrolytes. Thus, the electrode thicknesses in SO2-containing electrolytes are generally substantially thicker than 100 μm, generally thicker than 300 μm or even thicker than 600 μm.

In this case the electronically conductive substrate of the negative electrode can consist of an electronically conductive discharge element which may be made completely of metal, preferably nickel or stainless steel, or of carbon, such as carbon fiber woven or non-woven fabric. In an embodiment the electronically conductive substrate of the negative electrode can contain an active material, for example carbon, in a form suitable as insertion material. In this case the discharge element of the negative electrode preferably has a porous, i.e. three-dimensional structure, preferably in the form of a carbon fiber woven or non-woven fabric. In this case the porosity of the negative electrode filled with active material amounts to at most 50%, preferably 30%, wherein lower porosities are possible. In such an embodiment with a lithium-storing material, during charging of the cell first of all a part of the lithium resulting from the electrode reaction is stored in the negative electrode, however at least during a part of the charging the active metal is deposited in metallic form in the porous structure of the positive electrode.

In a preferred embodiment which is discussed below without limiting the generality, the electronically conductive substrate of the negative electrode of the cell only consists of an electronically conductive thin discharge element. These may for example be metal sheets or expanded metals, preferably made of nickel or stainless steel or also of nickel-plated metals, such as copper or aluminum, or also of carbon, such as carbon fiber woven or non-woven fabric. The discharge element has no significant mechanical function for the mechanical strength of the battery cell, so that its thickness can be established by means of the electronic internal resistance at maximum power drain from the cell. Thus, in the case of cells with a low capacity and with a low power drain thicknesses of less than 3 μm may be sufficient, and in the case of high performance cells with a high capacity thicknesses of more than 100 μm can become necessary.

By means of the assembly layer the electronically conductive substrate 12 borders on a porous structure 13 (porous positive electrode layer) containing the active material of the positive electrode in such a way that lithium (active metal of the negative electrode) deposited during charging of the cell penetrates into the pores 14. In this case the electronically conductive substrate 12 of the negative electrode is very much thinner than the porous positive electrode layer. Preferably, the porous positive electrode layer 13 is at least ten times as thick as the electronically conductive substrate 12.

In a preferred embodiment, only due to the assembly layer the electrodes 4 and 5 are arranged in separate layers, i.e. macroscopically separated partial spaces in the cell. At the same time the active material of the positive electrode is a structural component of a porous layer, in the pores of which the lithium is accommodated during charging of the cell and is deposited at least partially in metallic form. Thus, the conventional three-dimensional separation of the cell into discrete layers separated macroscopically from one another by a separator, except for the assembly layer, is not provided here. In a preferred embodiment, as described below, the cell contains only the two functional layers illustrated macroscopically in the drawings, namely the electronically conductive substrate 12 of the negative electrode and the porous positive electrode layer 13.

In order to avoid electronic short-circuits at the interface between the discharge element of the negative electrode and the porous structure containing the active material of the positive electrode, which can occur during the assembly of the cell, it may be advantageous to provide an additional layer, which is predominantly necessary only for the assembly of the cell, namely the assembly layer, between the two electrodes, by which an electronic conduction is prevented, but which is passable for the active metal resulting from the electrode reaction on the negative electrode during charging of the cell.

For this purpose, in particular, the substrate of the negative electrode or the outer surface of the porous positive electrode layer can be coated with a layer, which is electronically insulating but is transmissive, i.e. e.g. porous, for lithium ions and which is also passable for the active metal resulting during the first charging. Preferably, the layer thicknesses of this assembly layer are the smallest possible, for example less than 20 μm. A coating comprising finely ground particles, such as ceramic aluminum oxide or silicon dioxide, or such as salt-like lithium sulfide or lithium chloride, which are bonded for example Teflon-like, for example with THV is applied either to the positive electrode or to the negative electrode and.

However, it is preferable to use those particles which, as described below as an electrolyte-forming lithium dithionite, react with sulfur dioxide and aluminum chloride to electrolyte, so that the layer dissolves partially or completely after filling for example with a solution of sulfur dioxide and aluminum chloride. In this case the porous positive electrodes are arranged so closely on the substrate of the negative electrode that there are practically no longer any spaces between them and the chemical reactions can take place. The porous positive electrode layer, the layer 13 in FIG. 2, together with the electrolyte as well as the discharge element of the negative electrode forms the battery cell which thus has a very flat formation structure.

In an alternative embodiment it is possible to install a very thin, porous, electronically insulating layer material, such as for example a glass fiber fabric, which does not hinder later penetration of the active metal.

Furthermore, FIG. 2 shows structure-forming particles 16 of the porous positive electrode layer 13, which in the illustrated embodiment consist of the active material of the positive electrode 4. In this case the structure-forming particles are in such close and fixed contact that the necessary electronic conductivity is provided. The particles, preferably the surface of the positive electrode, are covered with carbon, preferably graphite or a sulfide. Furthermore, the structure-forming particles 16 are connected to one another by means of a binding agent 19, the quantity of which is such that it is only concentrated where the structure-forming particles 16 border on one another, but also numerous connecting channels remain. These connecting channels between the structure-forming particles, that is to say between the particles of the active material of the positive electrode, are the pores 14 of the porous structure. In this case the proportion of the active material in the porous structure of the positive electrode preferably amounts to 50%, preferably at least 80%.

In the preferred embodiment the porous structure of the positive electrode is configured so that the pore volume is suitable for accommodating the active metal (lithium) deposited during charging of the cell, so that an additional receiving volume for the active metal deposited during charging of the cell is not necessary. Thus the porosity of the positive electrode layer 13 should be so high that the entire pore volume is only insignificantly greater than the volume of the active metal maximally deposited on the substrate of the negative electrode during charging. Since the active metal of the negative electrode deposited in the SO2-containing electrolyte is deposited in the form of whiskers, the average pore diameter of the porous positive electrode layer should preferably be of the order of magnitude of the diameter of the metal whiskers. Since the calculation on the basis of the Berthelot-Roth product for explosion protection presupposes a homogeneous distribution of the components, in order to achieve practical explosion protection the average pore diameter should not exceed 500 μm, preferably 100 μm and particularly preferably 10 μm.

In order to improve the electronic conductivity of the electrodes, for the case where the electronic conductivity of the active material is not sufficient, an electronically conductive material can be contained in the structure-forming material as conductivity improver so that the active material has a so-called conductivity improver. Suitable conductivity improvers are for example soot, graphite, metal flakes. The proportion by weight of the conductivity improver on the electrode depends upon the electronic conductivity of the active material and preferably should not exceed 10% of the weight of the active material.

In an embodiment, in order to form the structure containing the active materials the structure-forming particles can be introduced into a foam, felt, woven or non-woven fabric made of metal, such as for example of nickel, tungsten, nickel-plated aluminum or copper. The foams, felt, woven or nonwoven fabrics are preferably carbon-coated. Electronic conductors made of carbon, such as carbon fiber woven and non-woven fabric are particularly preferred and novel. It is also possible to apply the structure-forming particles to a metal sheet or expanded metal by pressing.

Depending upon the adhesion of the structure-forming particles to one another or the size of the particles for example in relation to the spaces in the metal foam it is necessary for the mechanical strength of the electrode that the electrode contains a binding agent. In this case in particular fluorinated binding agents, such as THV or Teflon, have proved successful for the positive electrode. In an advantageous embodiment the binding agent is contained in a relatively small proportion by weight in the electrode, in particular proportions of binding agent of less than 10% of the weight of the active material are particularly preferred.

In the general embodiment the pores 14 of the layer 13 are filled with electrolyte 21 before the first charging operation. Methods are known by which it can be ensured that during filling the electrolyte also penetrates into fine pores of a porous layer. A suitable method is for example described in WO 2005/031908. In this case the electrolyte contains sulfur dioxide, i.e. is a SO2-containing electrolyte, wherein the volume of the electrolyte introduced into a battery cell is at most twice as great as the volume of the free pores of the porous structure of the positive electrode, preferably corresponding at most to the simple free volume of the pores of the positive electrode. Thus the battery cell only has the volume of electrolyte necessary for the efficient operation of the cell. This leads to an inherently safe battery cell.

Furthermore, FIG. 2 shows that the active metal 24, for example lithium, starting from the negative electrode grows into the pores 14 of the porous positive electrode layer 13 when it is deposited in metallic form during charging of the cell.

In conventional rechargeable battery cells the electronic separation of the active materials is achieved in that they are arranged by a separator into two spatially separate layers. In this case the separator is electronically non-conductive, but enables the ionic conduction, and can typically be a film or a glass fiber fabric which is porous, i.e. transmissive for ions. This necessary separation of the active materials 24, 17 of the two electrodes is ensured here by an intraporous separator layer 25 which covers the entire surface of the porous positive electrode layer 13.

In FIG. 2 this layer 25 is shown schematically as wrapping the structure-forming particles 16, that is to say the active material of the positive electrode. In other words, the intraporous separator layer covers the surface of the pores in which the lithium is deposited during the charging operation.

During charging of the battery cell lithium metal grows in a SO2-containing electrolyte in the form of cylindrical threads with a diameter of a few μm, so-called whiskers. In this case the whiskers begin on the electronically conductive substrate of the negative electrode and grow in the direction of the positive electrode. During this growth the lithium surface of the whiskers is covered with lithium dithionite by reaction of the lithium with sulfur dioxide. In this case the lithium dithionite which insulates electronically against the electrolyte forms at least one closed monolayer.

If the growing lithium metal whiskers encounter an electronically conductive surface of the positive electrode, for example a lithium cobalt oxide surface, an electronic short-circuit would be produced.

Surprisingly, however, a short-circuit does not occur if the lithium whisker grows towards a surface of a positive electrode which is covered by a layer of lithium dithionite. Such a lithium dithionite layer 25, which completely covers the surface of the positive electrode and insulates the positive electrode electronically from the whiskers, can be produced in situ after the assembly of a battery cell and filling with SO2-containing electrolyte, by suitable selection of the positive material, as described below.

In the SO2-containing electrolyte consisting of lithium tetrachloroaluminate and sulfur dioxide, electrode potentials are measured against metallic lithium dipping into the electrolyte (vs. Li/Li⁺).

On the surface of a positive substrate, i.e. the surface of the particles of the positive active material, the reduction of sulfur dioxide to lithium dithionite only takes place at potentials equal to or less than 3 V vs. Li/Li⁺. In this case at least one monolayer of this covering layer forms according to the following formula:

2Li⁺+2e−+2SO2 [symbol] Li2S2O4 (Eq. I)

In addition to falling short of a potential threshold, the type of substrate surface of the active material of the positive electrode is also a deciding factor as to whether, or at which potentials, a reduction of the sulfur dioxide takes place, and as to the products to which this leads.

From the chemical viewpoint the reduction of sulfur dioxide to lithium dithionite takes place very well on surfaces which according to the HSAB principle behave as soft bases, that is to say electron pairs which are easily polarizable, such as pi- or d-orbitals, for which rather soft acidic sulfur in the sulfur dioxide is available as a bonding partner. This includes substances such as graphite or sulfides which are well bound electronically. On graphite the lithium dithionite layer forms practically immediately in at least one monolayer at 3.0 V vs. Li/Li⁺. This layer is for example stable on graphite up to the lithium deposition.

If, as described below, a lithium dithionite molecule is chemically converted, this is immediately replicated on the surface when the potential of the positive electrode is equal to or less than 3.0 V vs. Li/Li⁺.

With lithium sulfide Li2S as active positive material the Li2S is oxidized to sulfur at approximately 2 V vs. Li/Li+. In this case the sulfur dioxide of the electrolyte is reduced directly to lithium dithionite on the surface of the positive electrode, that is to say the particles 16. Accordingly, the required lithium dithionite layer forms everywhere where the active material of the positive electrode comes into direct contact with the SO2-containing electrolyte, that is to say during filling with the electrolyte after the assembly of the battery cell, when the electrolyte penetrates into the pores of the porous structure of the positive electrode.

This reaction corresponds to the reaction of a charging operation on the positive electrode and thus decreases the capacity of the battery cell, since the lithium ions used for production of the lithium dithionite layer are no longer available for metallic deposition during the charging operation. However, this can be compensated for in practice by a suitable compensation measure, as described below.

Thus in one embodiment the required lithium dithionite layer on the surface of the porous positive electrode layer, that is to say on the surface of the particles of the active material of the positive electrode, forms precisely when the positive active material has a redox potential of less than or equal to 3.0 Volt vs. Li/Li⁺.

Lithium iron phosphate may be mentioned as an example of an active positive material of a 3 V system for the preferred embodiment. Since the lithium iron phosphate which is currently available commercially is thoroughly covered with a layer of carbon, one of the above-mentioned preferred prerequisites for covering the porous positive electrode layer with carbon is already met.

In the potential range between approximately 3.0 V and 4.0 V vs. Li/Li⁺ a chemically converted lithium dithionite molecule is not replaced, so that the intraporous separator layer can have gaps at which short-circuits can occur.

At approximately 4.0 V vs. Li/Li⁺ an over-charging reaction starts in the SO2-containing electrolyte, resulting in the formation of sulfuryl chloride, which in turn oxidatively converts the lithium dithionite. During this over-charging reaction, the anion of the conducting salt, in this case tetrachloroaluminate, oxidizes to chlorine on the positive electrode, wherein the chlorine reacts further with sulfur dioxide to produce sulfuryl chloride. The potential at which this reaction starts is substantially dependent upon the composition of the electrolyte and the temperature and can be easily determined using measuring techniques. In any case this over-charging reaction should be avoided.

The above described potential intervals restrict the selection to positive active materials. Table 1 lists the redox potential with its charging and discharging intervals for several positive active materials which are possible here. The above-mentioned condition that the positive active material may be charged to a maximum of below 4.0 Volt vs. Li/Li⁺ is important for the selection of the positive active material.

TABLE 1

| | | Practical |
|---|---|---|
| | | specific |
| | | energy |
| | | with regard |
| | Average | to active |
| | potential | material |
| Material | V vs. Li/Li⁺ | Wh/kg |
| 3 V systems: | | |
| LiFePO₄ (LFP) | 3.45 | 587 |
| LiV₃O₈ | 3.2 | 960 |
| LiMnO₂ | 3.0 | 585 |
| LiFeBO₃ | 3.0 | 595 |
| 2 V systems: | | |
| LiTiS₂ | 2.1 | 426 |
| Li₂S | 2.0 | 800 |
| Li₄Ti₅O₁₂ | 1.5 | 263 |

In a preferred embodiment favorable positive active materials in the SO2-based electrolyte for the potential range less than or equal to 3.0 V vs. Li/Li⁺ are oxidic materials, such as Li₄Ti₅O₁₂, or sulfur-containing materials, such as Li₂S or LiTiS₂, or other active materials of which the incorporation and removal potential or redox potential for the lithium ions is below 3.0 V vs. Li/Li⁺. Thus active materials of the positive electrode with this redox potential ensure that the surface of the porous positive electrode layer is permanently protected by a lithium dithionite layer.

The potential of the positive electrode should preferably be permanently less than or equal to 3.0 V vs. Li/Li⁺. A charging once or several times to above 3.0 V but below 4.0 V vs. Li/Li⁺ is possible. Though the lithium dithionite is converted on the positive electrode in accordance with the self-discharge process described below, but—as described above—the lithium dithionite layer is replicated on the surface of the positive electrode as soon as the potential reaches or falls short of 3.0 V vs. Li/Li⁺.

Before the surface of the porous positive electrode layer is covered by the lithium dithionite layer, it is preferably mostly or completely covered with, for example, graphite or similar carbon or sulfides.

In this case particular preference is given to active positive materials consisting of lithium sulfide carbon (Li₂S/C) which are produced, for example, according to a dry ball mill process from lithium sulfide and carbon black or by a special chemical process according to WO 2012/171889.

In an alternative exemplary embodiment, a positive active material with a redox potential of more than 3.0 Volt vs. Li/Li⁺ can be used. In order to produce the lithium dithionite layer on the surface of the positive electrode, that is to say the particles of the positive material which form the porous structure, before the first operation, i.e. the first charging of the cell, it is necessary to lower the potential of the positive electrode to a value less than or equal to 3.0 Volt vs. Li/Li⁺ so that the lithium dithionite layer can form.

The following Table 2 lists the redox potentials with their charging and discharging intervals of several known positive active materials with a redox potential of close to 4 Volt vs. Li/Li⁺, which are generally charged to above 4.0 V vs. Li/Li⁺ and, because of the formation of sulfuryl chloride and the resulting destruction of the lithium dithionite layer as positive active material, do not generally come into consideration:

4 V systems:

| | | Practical |
|---|---|---|
| | | specific |
| | | energy |
| | | with regard |
| | Average | to active |
| | potential | material |
| Material | V vs. Li/Li⁺ | Wh/kg |
| LiCoO₂ (LCO) | 3.9 | 546 |
| LiNi_{0.8}Co_{0.15}Al_{0.05}O₂ (NCA) | 3.8 | 760 |
| LiNi_{1/3}Co_{1/3}Mn_{1/3}O₂ (NMC) | 3.8 | 650 |
| LiMn₂O₄ (LMO) | 4.1 | 492 |

In a further aspect the invention relates to a SO2-containing electrolyte which is proof against self-discharge for use in rechargeable battery cells.

Although the SO2-containing electrolyte is described here in the context of the above-mentioned battery cell, the electrolyte can be used for other suitable battery cells which are not explicitly described here and are designed for SO2-containing electrolytes.

In a preferred embodiment the electrolyte described below can be used in particular in conjunction with the positive electrode described above and covered by lithium dithionite. Furthermore, the novel electrolyte described here can be operated with a positive electrode which, as described below, uses lithium sulfide, Li2S, as active material.

The SO2-containing electrolyte LiAlCl4×n SO2 is discussed below without limiting the generality. In this case electrolytes in which the factor n varies between 1.5 and 22 are described in the literature.

For the electrolyte with n=1.5 it is known that with a density of 1.7 kg/l it contains approximately 6.2 Mol lithium tetrachloroaluminate and approximately 9.4 Mol sulfur dioxide per liter. The liquid is as clear as water and has a sulfur dioxide vapor pressure of less than 0.1 bar at room temperature. The boiling point is 70° C.

The electrolyte with n=4.5, likewise with a density of 1.7 kg/l, contains approximately 3.7 Mol lithium tetrachloroaluminate and approximately 16.5 Mol sulfur dioxide per liter. The liquid is as clear as water and has a sulfur dioxide vapor pressure of more than 2 bars at room temperature.

The electrolyte with n=22, with a density of almost 1.6 kg/l, contains approximately 1 Mol lithium tetrachloroaluminate and 22 Mol sulfur dioxide per liter. The liquid is as clear as water and has a sulfur dioxide vapor pressure of almost 3 bars at room temperature.

Because of the low sulfur dioxide content and the low vapor pressure at room temperature an electrolyte with a low n, such as n=1.5, for use in rechargeable battery cells is preferred, since battery cells configured in this way only have to have a comparatively low mechanical strength, for example of the housing.

As also described in the patent literature, such an electrolyte can be produced from lithium chloride, aluminum chloride and sulfur dioxide. In this case particular importance is attached to the dryness of the resulting electrolyte, which in particular necessitates elaborate processes for drying the highly hygroscopic lithium chloride or mixtures or molten masses of lithium chloride and aluminum chloride.

In this respect water in the electrolyte is very disruptive, since it reacts with aluminum chloride to hydrogen chloride and aluminum oxychlorides. On the negative electrode the hydrogen chloride is reduced to hydrogen, which may lead to a marked increase in pressure in the cell and thus to the destruction of the battery cell due to rupture.

On the positive electrode hydrogen chloride reacts once by incorporation of protons into the host lattice, which leads to the reduction of the capacity of the electrode, and additionally often with irreversible damage to the host lattice by for example reaction of transition metal ions of the host lattice with the chloride of the hydrogen chloride.

The water content of the electrolyte is measured using the Karl-Fischer method which is known per se and which strictly speaking determines the content of aluminum oxychlorides. According to WO2011EP00506 low Karl-Fischer-values would be particularly advantageous.

As described above, below a potential of 3.0 V vs. Li/Li⁺ a covering layer of lithium dithionite forms in the SO2-containing electrolyte by reduction of sulfur dioxide on a positive graphite-containing electrode. If the potential of this graphite electrode having a covering layer is kept constant for example at 2.8 V vs. Li/Li⁺, in the SO2-containing electrolyte by a corresponding electronic device (potentiostat), a falling current can be observed which corresponds to the self-discharge of the graphite electrode.

This self-discharge current is smaller at a higher SO2 content than at a low SO2 content. Although lithium dithionite on the surface of the positive electrode is a stable molecule, by this self-discharge reaction it is shown that a chemical conversion of lithium dithionite takes place with consumption and then new formation of lithium dithionite which can be derived from the potential level.

During the production of the electrolyte it is preferably ensured that lithium chloride is introduced in excess. Thus the produced electrolyte is saturated with lithium chloride according to the weak solubility of lithium chloride in the lower percentage range. An acidic electrolyte produced with a stoichiometric excess of aluminum chloride increases, just like an increase in temperature, the self-discharge current of the graphite electrode.

However, this reaction is slowed down or comes to a standstill when the electrolyte contains a high proportion of oxides and thus has a high Karl-Fischer value. This may be explained as follows.

In the potential range below the over-charging reaction in the SO2-containing electrolyte there is only one single reaction sequence which leads to the conversion of lithium dithionite in the context of a self-discharge reaction.

The initial reaction of the reaction sequence is the autodissociation of the dissolved conducting salt, in this case using the example of lithium tetrachloroaluminate in sulfur dioxide:

Li⁺+AlCl4− [symbol] LiCl+AlCl3

The lithium ion reacts with a chloride of the tetrachloroaluminate anion by the formation of aluminum chloride and lithium chloride. Under normal conditions the equilibrium is almost completely on the left side.

The lithium dithionite formed on the surface of the graphite according to equation I is stable in the SO₂-containing electrolyte. It then reacts as follows only with the autodissociatively formed aluminum chloride in the reaction sequence to lithium thiosulfate, sulfur dioxide, lithium ion and oxochloroaluminate as well as chloride ion:

2Li2S2O4+AlCl3 [symbol] Li2S2O3+2SO2+Li⁺+AlOCl2⁻+Li⁺+Cl⁻ (Eq. II)

This reaction is an equilibrium reaction. So long as lithium thiosulfate is still located on the surface, the reverse reaction to lithium dithionite is dependent inter alia upon the concentration of the reactants on the right side of the equation. As already stated above, the solubility of the chloride ion is low, so that lithium chloride will be precipitated in particular in a chloride-saturated solution. The higher entropy is located on the right side, so that with increasing temperature the equilibrium shifts to the right in the direction of the products. Thus the equilibrium to be newly set at a higher temperature necessitates a higher concentration of the products. Likewise, the reaction rate increases, so that also for this reason the self-discharge current of the graphite electrode, as measured, rises.

In this case oxochloroaluminate includes not only AlOCl₂⁻ but also further anions containing aluminum, chlorine and oxygen, such as for example Al₂O₂Cl₄²⁻ or also Al₂O₃Cl₂²⁻. These are detectable as aluminum oxychlorides, as stated above, quantitatively in total using Karl-Fischer analysis.

The lithium thiosulfate which is formed reacts with the tetrachloroaluminate anion slowly in a further equilibrium reaction to the products sulfur, sulfur dioxide, chloride ion, lithium ion and oxochloroaluminate:

Li2S2O3+Li⁺+AlCl4⁻ [symbol] S+SO2+Li⁺+AlOCl2⁻+2Li⁺+2Cl⁻

Here too, when the solubility product is exceeded lithium chloride is precipitated. At the same time according to equation I the lithium dithionite is replicated, so that the covering layer on the positive electrode is replicated autonomously.

At potentials below 2.0 V vs. Li/Li⁺ (see below) the sulfur which is formed, if it is electronically bound, is further reduced to lithium sulfide.

The overall brutto-reaction (without new formation of lithium dithionite) is then:

a) For the potential range between 2 V and 3 V vs. Li/Li⁺:

4Li⁺+4e⁻+1SO2+2LiAlCl4 [symbol] S+2Li⁺+2AlOCl2⁻+4LiCl (Eq. IIIa)

b) For the potential range between 0 V and 2 V vs. Li/Li⁺:

6Li⁺+6e⁻+1SO2+2LiAlCl4 [symbol] Li2S+2Li⁺+2AlOCl2⁻+4LiCl (Eq. IIIb)

In these reactions lithium chloride (from the electrolyte which is preferably saturated with lithium chloride), sulfur or lithium sulfide are precipitated as solid materials.

The equilibrium according to equation II may be described as follows for the case of the electrolyte which is preferably saturated with lithium chloride:

K=k×[SO2]²×[Li⁺]×[AlOCl2⁻]/[AlCl3] (Eq. IV)

where K and k are any real constants. Thus with the inclusion of the equation for the autodissociation it follows that:

K=k′×[SO2]²×[Li⁺]×[AlOCl2⁻]/([Li⁺]×[AlCl4⁻]) (Eq. IVa)

where K and k′ again are any real constants.

If the equilibrium condition according to equation IVa is met, no further self-discharge reaction takes place, wherein the sulfur dioxide concentration is quadratically included and the lithium oxochloroaluminate concentration is included linearly in the equation.

Thus if a Li—SO2 cell, i.e. a battery cell with lithium as active cation and a sulfur dioxide-containing electrolyte, which contains for example graphite as active material of the negative electrode, were filled with conventional electrolytes and then charged, the self-discharge reaction described above takes place with the formation of lithium oxochloroaluminate until the equilibrium is set according to equation IVa. Depending upon how high the sulfur dioxide concentration of the conventional electrolyte is, this self-discharge reaction which takes place on the negative electrode according to equation IIIb can use a majority or all of the total capacity of the cell. The self-discharge reaction on the negative electrode is accelerated by constant charging and discharging of the cell, since during charging fresh graphite surface is continually generated due to the increase in volume of the graphite. In the event of a temperature increase the self-discharge rate of the cell is raised and the equilibrium is shifted in the direction of a higher sulfur dioxide concentration or higher oxochloroaluminate concentration, respectively.

The period of time until, at a given temperature, an equilibrium is reached or until the capacity of the cell is completely consumed, respectively, is generally several months to years and necessitates many hundreds or thousands of complete charging and discharging cycles. Thus a battery cell with a conventional sulfur dioxide-containing electrolyte would reach an equilibrium only after a long time or a large number of charging and discharging cycles, wherein then the capacity of the battery cell would be mostly or completely consumed and thus would be unusable. Thus such a battery cell has the disadvantage of a constant self-discharge.

Therefore, there is a need for a new SO2-containing electrolyte.

For this purpose, a new inorganic electrolyte of the stoichiometric formula

(yLiAlCl4+zLiAlOCl2)×nSO2,

is proposed, where y, z and n are factors, with y+z=1 and 1≧z>0.05.

The necessary magnitude of z can be determined from the self-discharge curve at a given SO2 concentration. The higher z is in relation to y, the smaller the sulfur dioxide content of the electrolyte can be. Preferably z should be so great that n is less than or equal to 1.5.

The loss of capacity of a Li—SO2 cell during formation of the first covering layer by the reduction of sulfur dioxide to lithium dithionite can be compensated for by covering layer capacity compensation measures, as described below.

Particularly preferably the Li—SO2 cell is filled with the novel inorganic electrolyte LiAlOCl₂×n SO₂ (y close to or equal to 0, z close to or equal to 1), so that even in the case of substantial temperature increases no loss of capacity takes place due to self-discharge and the amount of sulfur dioxide in the electrolyte can be kept very low.

Three novel methods are provided alternatively or in combination for production of the novel electrolyte solution. Metallic lithium is used in the method. Since in the presence of sulfur dioxide metallic lithium is immediately covered with a stable covering layer of lithium dithionite, the reaction is carried out for example in a ball mill flushed with sulfur dioxide gas:
1. According to the equation IIIb lithium metal reacts with conducting salt and sulfur dioxide or with conventional electrolyte:

6Li⁺1SO2+2LiAlCl4 [symbol] Li2S+2Li⁺+2AlOCl2⁻+4LiCl
The reaction is highly exergonic and accelerates easily by itself once started locally. For heat removal and better reaction monitoring the reaction can be implemented in a more controlled manner in a solvent consisting of saturated hydrocarbons.
In practice a favorable solution is to carry out the reaction in a ball mill flushed with sulfur dioxide gas. If for example a mixture of lithium metal pieces with the salt lithium tetrachloroaluminate is ground in the ball mill, the delivery of sulfur dioxide gas determines the speed at which the reaction proceeds and thus the heat production. Instead of the salt lithium tetrachloroaluminate a conventional electrolyte, preferably with a very low SO2 content, can also be used.
2. Without elaborate production of a conventional dry electrolyte the following procedure may be used:

6Li⁺1SO2+4AlCl3 [symbol] Li2S+2Li⁺+2AlOCl2⁻+2Li⁺+2AlCl4⁻
The reaction is likewise highly exergonic and accelerates easily by itself. For heat removal and better reaction monitoring the reaction can be implemented in a more controlled manner in a solvent consisting of saturated hydrocarbons.
Here too, the reaction management described above is a possible solution. Instead of the salt lithiumtetrachloroaluminate the salt-like aluminum chloride with sulfur dioxide-gas or a solution of aluminum chloride in sulfur dioxide is used.
3. A two-stage method similar to the second method likewise functions without the elaborate production of a dry electrolyte:
   First of all, the electrolyte-forming lithium dithionite is produced from lithium metal and sulfur dioxide gas:

2Li⁺2SO2 [symbol] Li2S2O4
For better reaction monitoring a solvent consisting of saturated hydrocarbons can also be used here.
The reaction management preferably also takes place here in a ball mill, wherein the heat of reaction can be controlled by means of the sulfur dioxide gas supply.
In the next step the lithium dithionite powder with the addition of aluminum chloride and preferably in the presence of sulfur dioxide gas or with the addition of an aluminum chloride/sulfur dioxide solution is reacted to produce sulfur, sulfur dioxide, lithium oxochloroaluminate and lithium tetrachloroaluminate. This reaction step can also be carried out in saturated hydrocarbons.

2Li2S2O4+4AlCl3 [symbol] S+3SO2+2Li⁺+2AlOCl2⁻+2Li⁺+2AlCl4⁻

Solids or the optionally used solvent consisting of saturated hydrocarbons can be separated off in each reaction step or method. The desired n can be set in the processes or subsequently by further flushing with sulfur dioxide gas or evacuation of the sulfur dioxide.

A combination of the production methods, such as for example method 3. with subsequent method 1., is likewise possible in order on the one hand to produce the pure lithium oxochloroaluminate electrolyte and on the other hand to avoid a elaborate drying process for production of a dry conventional electrolyte.

The positive active material of the positive electrode is in contact with the electrolyte in the cell and therefore primarily can only react therewith. Therefore, the electrolyte is crucial for possible reactions of the materials contained in the electrodes. A problematic characteristic of a SO2-containing electrolyte is its high corrosiveness.

A plurality of different compounds can be used as positive active material. For battery cells with lithium or an equivalent metal and a sulfur dioxide-containing electrolyte, positive active materials can be used which are typical for conventional battery cells and are based on an oxide, in particular of lithium cobalt oxide as a 4 V system, or of a phosphate, in particular of lithium iron phosphate as a 3 V system.

In a further aspect the invention relates to a battery cell with a negative electrode, a positive electrode and an electrolyte, wherein the active material of the positive electrode contains lithium sulfide, Li2S.

In this case the positive electrode of the battery cell in one embodiment can have a porous structure with the intraporous separator layer likewise described above. As an alternative to this the positive electrode can have any structure, for example a conventional structure as well as a lithium dithionite layer on the surface of the porous positive electrode layer as separator layer or alternatively a conventional separator layer.

Furthermore, the battery cell has an electrolyte. In one embodiment this electrolyte may be a conventional electrolyte. Alternatively, the battery cell can have any SO2-containing electrolyte. In a preferred embodiment the battery cell can have the SO2-containing electrolyte described above.

In this case the positive electrode and, in the general embodiment, also the negative electrode has a porous structure, as described above. The porous structure is generally at least partially filled with electrolyte. Since the ionic conductivity of the electrolyte is generally higher by several orders of magnitude than the ionic conductivity in the active materials, with a sufficient porosity an adequate ion conductivity within the electrodes is ensured. The porosity of the electrodes should generally be at least 10%, preferably more than 25%.

In a preferred embodiment the embodiments of the battery cell described above can have a positive electrode with an active material which contains lithium sulfide, Li2S, as active metal. In this case active positive materials consisting of lithium sulfide carbon, Li2S/C, are particularly preferred. The reason for the preference lies in the extremely low solubility of sulfur or polysulfanes, respectively, in the SO2-based electrolyte. Lithium sulfide can be produced by means of different chemical processes which are described for example in WO 2012/171889. The particularly preferred lithium sulfide carbon, Li2S/C, can be produced from lithium sulfide, Li2S, and so-called carbon black, carbon, by means of a dry ball mill process or according to a method described in WO 2012/171889.

As the following table shows, Li2S is a 2 Volt system by comparison with Li/Li⁺. Thus although by comparison with other battery cells the cell has a comparatively low voltage, a battery cell with Li2S as positive active material can store considerable energy per material.

2 V systems:

| | | Practical |
|---|---|---|
| | | specific |
| | | energy |
| | | with regard |
| | Average | to active |
| | potential | material |
| Material | V vs. Li/Li⁺ | Wh/kg |
| LiTiS2 | 2.1 | 426 |
| Li2S | 2.0 | 800 |
| Li4Ti5O12 | 1.5 | 263 |

At the latest during the first charging operation the covering layer of lithium dithionite is formed directly in the particularly preferred battery cell with lithium sulfide, Li2S, as active positive material on the surface of the positive electrode layer, since the charging operation takes place below 3V vs. Li/Li₊. The growth of the metallic lithium whiskers, which with increasing charge penetrate into the pores of the preferred positive electrode, begins on the negative electrode. In this case the cell voltage is typically less 3 V, so that coverage of the surface of the positive electrode with lithium dithionite is maintained in normal operation. However, for activation of the positive electrode the cell can be charged to a maximum of <4 V.

During discharging of the cell the metallically deposited lithium is dissolved again oxidatively in the negative electrode and sulfur is again reduced to lithium sulfide in the positive electrode.

The capacity of the covering layer of lithium dithionite on the positive electrode layer is preferably compensated by a method as described below.

Furthermore, the cell is proof against deep discharge, regardless of whether the positive or the negative electrode determines the capacity, i.e. is discharged first at the end of discharging of the cell. If the negative electrode determines the capacity, after the complete dissolution of the lithium the potential of the discharge element rises from 0 V vs. Li/Li⁺ to the potential of the positive electrode of for example 2 V vs. Li/Li⁺, wherein the cell voltage reverts to 0 V. If the positive electrode determines the capacity, the potential of the positive electrode falls to 0 V vs. Li/Li⁺ and the cell voltage drops to 0 V. Since the active material lithium sulfide cannot be further reduced, no further chemical reaction takes place for the lithium sulfide. Depending upon whether, or to what extent, graphite fractions are contained in the carbon which covers the lithium sulfide, a reversible incorporation of lithium ions in the graphite takes place at approximately 0.3 V vs. Li/Li⁺. The lithium dithionite layer is stable in all cases.

In the preferred embodiment, with compensation for the covering layer capacity as described below, the cell reaches a specific energy of over 400 Wh/kg and an energy density of over 1000 Wh/l. As shown by the table set out above for 2 V systems, these values are very high and therefore advantageous by comparison with 2 V systems of other positive materials, for example Li4Ti5O12.

In the event of slight over-compensation of the covering layer capacity of the positive electrode (as described below) the capacity of the cell is then determined by the quantity of lithium deposited on the negative electrode. Because of the high cycle stability of lithium titanate in the SO2-based electrolyte, i.e. a decrease in capacity of the lithium titanate due to frequent charging and discharged cannot be ascertained in practice, then the negative electrode determines the capacity. In the case of deep discharge of the cell to 0 V, is all the metallic lithium is then dissolved. During the deep discharge the potential of the electronically conductive substrate of the negative electrode, e.g. a nickel plate, rises from 0 V vs. Li/Li⁺ to the potential of the positive electrode (approximately 1.5 V vs. Li/Li⁺ depending upon the state of charge). The measured cell voltage drops to 0 V. The covering layer of lithium dithionite on the surface of the discharge element does not change up to approximately 4 V vs. Li/Li⁺, so that even up to a cell voltage up to minus 2.5 V the cell could be driven into reverse polarity. Thus in any case the cell is proof against deep discharge up to 0 V cell voltage.

In the preferred embodiment in the SO2-containing electrolyte the potential range between 3.0 and 4.0 V vs. Li/Li⁺ is also possible for active positive materials when it is ensured that the surface is coated with carbon or another conductive material providing pi- or d-electrons.

For such cells, which are produced for example in the completely discharged state and of which the stock of lithium ions hence is contained in the active positive material, during the first charge it must be ensured that first of all a covering layer of lithium dithionite forms on the porous positive electrode layer. On the one hand the covering layer capacity necessary therefore can be introduced by the method described below directly into the positive electrode; then the covering layer of lithium dithionite on the porous positive electrode layer would form directly by reduction of sulfur dioxide. Alternatively, with the method described below the discharge element of the negative electrode would be provided with the covering layer capacity compensation. The cell would then be discharged once before the first charging, so that in this case the lithium dithionite layer would form on the surface of the porous positive electrode layer.

In the event of slight over-compensation of the covering layer capacity of the positive electrode (as described below) the capacity of the cell is then determined by the quantity of lithium deposited on the negative electrode. Because of the high cycle stability of lithium iron phosphate in the SO2-containing electrolyte, i.e. a decrease in capacity of the lithium iron phosphate due to frequent charging and discharged cannot be ascertained in practice, then the negative electrode determines the capacity. In the case of deep discharge of the cell to 0 V, is all the metallic lithium is then dissolved. During the deep discharge the potential of the electronically conductive substrate of the negative electrode, e.g. a nickel plate, rises from 0 V vs. Li/Li⁺ to the potential of the positive electrode (approximately 3 V vs. Li/Li⁺ depending upon the state of charge). The measured cell voltage drops to 0 V. In practice the covering layer on the surface of the discharge element does not change up to approximately 4 V vs. Li/Li⁺, so that even up to a cell voltage up to minus 1 V the cell could be driven into reverse polarity. Thus the cell is proof against deep discharge at least up to 0 V cell voltage.

If a cell according to one of the embodiments described above is filled with a conventional electrolyte, it is advantageous, in addition to the compensation of the covering layer capacity/ies, to compensate for the capacity of the self-discharge caused by a chemical reaction sequence, as described above, between electrolyte and lithium dithionite. Advantageously that means here without compensation of the covering layer capacity and the capacity consumed by self-discharge the cell has a substantially lower capacity and thus substantially lower characteristic values of the specific energy and the energy density. A disadvantage is the process of compensation for the self-discharge, which, due to the slowness of the self-discharge, lasts for months or up to a year. It could be speeded up somewhat by increasing the temperature. In order to speed up the self-discharge and thus, as described below, a compensation for the capacity of the self-discharge in the cell, filling up with an acidic aluminum chloride electrolyte would also be helpful, since the formed lithium dithionite is converted more quickly according to equation II.

In a further aspect the invention relates to methods for producing from electrodes with a covering layer capacity compensation and with a compensation for the capacity of the self-discharge for battery cells which are suitable for SO2-containing electrolytes.

Depending upon the embodiment and use of active negative or positive materials on the negative electrode or on the positive electrode or on both electrodes, a covering layer of lithium dithionite can be formed in a Li—SO2 cell. When conventional electrolytes are used, as described above the formed lithium dithionite reacts further with the electrolyte, until the equilibrium, equation IVa, is set.

The capacities which are consumed in the formation and the further reaction of the lithium dithionite reduce the capacity the battery cell.

These losses of capacity can be compensated for by the introduction of an equivalent quantity of metallic lithium into the battery cell. The introduction of the metallic lithium into the battery cell can take place during the production of the negative electrode as described below. Alternatively, the metallic lithium can also be introduced into the cell in an analogous manner during the production of the positive electrode.

In a first method step of a production method described by way of example the active negative material, in an exemplary embodiment graphite, is mixed with a binder in a solvent. This mixture typically has the consistency of a paste with a higher viscosity.

In the next step this mixture is applied to the planar discharge element of the negative electrode or, in the case of a three-dimensional discharge element, such as for example nickel foam, is pasted in.

In a further method step the solvent is vaporized for example by drying by the supply of heat.

Next, the electrode blanks which are now solvent-free are rolled and thus compressed. Finally, the electrodes are cut to size.

During the production of electrodes for battery cells which are suitable for SO2-containing electrolytes, the metallic lithium can now be, in any form, rolled into the electrode either into the solvent free electrode blanks before the rolling or, in an additional step, into the rolled electrode blanks or into the electrodes cut to size, respectively.

In one embodiment the metallic lithium in the form of a film of metallic lithium can be placed onto the electrode blank or onto the electrode and can be rolled in. In an alternative embodiment the metallic lithium in the form of a dry particulate powder can be placed onto the electrode blank or onto the electrode and can be rolled in. In a further alternative embodiment particulate lithium, in particular particulate metallic lithium/lithium sulfide composite, which is provided for example with a protective coating, can be applied and rolled in. Methods for production of the preferably particulate metallic lithium/lithium sulfide composite are known from WO2013/068523, to which reference is made here in its full scope.

Thus, both the negative electrode and/or the positive electrode can have a layer which contains metallic lithium, and which has preferably been introduced into the porous electrode(s) before the assembly of the battery cell.

In one embodiment, in order to prevent an adhesion of the lithium, both in the form of the metallic film and also in particulate form on the roller, in the rolling operation with a metal roller a polymeric film of, for example, polyethylene or polypropylene can be guided as a separating agent between lithium and roller. As an alternative, a corresponding roller with a corresponding polymeric surface, for example a polyethylene or polypropylene surface, can be used for the rolling in.

Because of the reactivity of the metallic lithium the conditions of a dry room have to be met. A reduced reactivity of the coated lithium metal also leads to a reduction in the requirements relating to the water content of the dry room during the introduction of the lithium metal or in the following assembly, respectively.

1. A rechargeable non-aqueous electrochemical battery cell with
a negative electrode with an electronically conductive substrate, and
a sulfur dioxide-containing electrolyte and
a positive electrode with a porous structure, wherein the active material of the positive electrode is contained in the porous structure, and wherein the active material of the positive electrode is arranged in the vicinity of the electronically conductive substrate of the negative electrode, that
wherein at least a part of the active metal resulting from the electrode reaction on the negative electrode penetrates into the pores of the positive electrode, and wherein the surface of the positive electrode is covered at least partially by a layer which contains metal dithionite.

2. The battery cell according to claim 1, wherein the active material of the positive electrode in the electrolyte has a redox potential of less than or equal to 4.0 Volt vs. Li/Li⁺.

3. The battery cell according to claim 1, wherein the active material of the positive electrode in the electrolyte has a redox potential of less than or equal to 3.0 Volt vs. Li/Li⁺.

4. The battery cell according to claim 1, wherein the active material of the positive electrode is contained in the porous structure in a proportion by weight at least 50%, preferably at least 80%.

5. The battery cell according to claim 1, wherein the surface of the positive electrode is covered with carbon or a sulfide.

6. The battery cell according to claim 1, wherein a discharge element of an electrode contains carbon, and preferably has carbon fiber woven fabric or carbon fiber non-woven fabric.

7. The battery cell according to claim 1, wherein the sulfur dioxide-containing electrolyte predominantly contains electrolytes which according to the stoichiometric formula (y LiAlCl4+z LiAlOCl2)×n SO2 have a composition with y+z=1 and 0.05<z≦1, n>0.

8. The battery cell according to claim 7, wherein the electrolyte has at least one of the following conducting salts, such as halides, oxalates, borates, phosphates, arsenates or gallates or further solvents.

9. The battery cell according to claim 7, wherein n≦3.5, particularly preferably n≦1.5.

10. The battery cell according to claim 7, wherein z≧0.1, particularly preferably z≧0.5.

11. The battery cell according to claim 7, wherein the positive active material includes lithium sulfide, Li2S.

12. The battery cell according to claim 7, wherein during the process of manufacturing an electrode the active material of the electrode is mixed with a solvent and then applied to or pasted into the discharge element of the electrode, and wherein the solvent is removed and after the removal of the solvent a layer which contains metallic lithium has been applied to or introduced into the negative electrode and/or the positive electrode before the assembly of the battery cell.

13. A rechargeable non-aqueous electrochemical battery cell with
a negative electrode, and
a positive electrode, and
a sulfur dioxide-containing electrolyte, wherein the sulfur dioxide-containing electrolyte predominantly contains electrolytes which, according to the stoichiometric formula (y LiAlCl4+z LiAlOCl2)×n SO2 have a composition with y+z=1 and 0.05<z≦1, n>0.

14. The battery cell according to claim 13, wherein the electrolyte has at least one of the following conducting salts, such as halides, oxalates, borates, phosphates, arsenates or gallates or further solvents.

15. The battery cell according to claim 13, wherein z≧0.1, particularly preferably z≧0.5.

16. The battery cell according to claim 13, wherein the positive electrode contains lithium sulfide, Li2S, preferably a lithium sulfide/carbon composite, as active material.

17. The battery cell according to claim 13, wherein during the process of manufacturing an electrode the active material of the electrode is mixed with a solvent and then applied to or pasted into the discharge element of the electrode, and wherein the solvent is removed and after the removal of the solvent a layer which contains metallic lithium has been applied to or introduced into the negative electrode and/or the positive electrode before the assembly of the battery cell.

18. The battery cell according to one of claim 13, wherein a discharge element of an electrode contains carbon, and preferably has a carbon fiber woven fabric or carbon fiber non-woven fabric.

19. A method for production of an electrolyte for use in a battery cell, wherein the electrolyte is produced according to the reaction equation
Li+1SO2+2LiAlCl4 [symbol] Li2S+2Li⁺+2AlOCl2⁻+4LiCl

20. Method according to claim 19, wherein the reaction takes place in a solvent consisting of saturated hydrocarbons.

21. A method for production of an electrolyte for use in a battery cell, wherein the electrolyte is produced according to the reaction equation
Li+1SO2+4AlCl3 [symbol] Li2S+2Li⁺+2AlOCl2⁻+2Li⁺+2AlCl4⁻

22. Method according to claim 21, wherein the reaction takes place in a solvent consisting of saturated hydrocarbons.

23. A method for production of an electrolyte for use in a battery cell, with the steps
production from lithium dithionite from lithium metal and sulfur dioxide gas according to the reaction equation
2Li+2SO2 [symbol] Li2S2O4
conversion of the lithium dithionite according to the reaction equation
2Li2S2O4+4AlCl3 [symbol] S+3SO2+2Li⁺+2AlOCl2⁻+2Li⁺+2AlCl4⁻.

24. Method according to claim 23, wherein at least one of the reaction steps takes place in a saturated hydrocarbon.

25. A rechargeable non-aqueous electrochemical battery cell with
a negative electrode with an electronically conductive substrate, and
a positive electrode, and
a sulfur dioxide-containing electrolyte,
wherein the positive electrode contains lithium sulfide, Li2S, as active material.

26. The battery cell according to claim 25, wherein the positive electrode has a porous structure and the active material of the positive electrode is arranged in the vicinity of the electronically conductive substrate of the negative electrode, wherein at least a part of the active metal resulting from the electrode reaction on the negative electrode penetrates into the pores of the positive electrode.

27. The battery cell according to claim 25, wherein the surface of the positive electrode is covered at least partially by a layer which contains metal dithionite.

28. The battery cell according to claim 25, wherein the sulfur dioxide-containing electrolyte predominantly contains electrolytes which according to the stoichiometric formula (y LiAlCl4+z LiAlOCl2)×n SO2 have a composition with y+z=1 and 0.05<z≦1, n>0.

29. The battery cell according to claim 25, wherein the electrolyte has at least one of the following conducting salts, such as halides, oxalates, borates, phosphates, arsenates or gallates or solvents.

30. The battery cell according to claim 25, wherein n≦3.5, particularly preferably n≦1.5 and wherein z≧0.1, particularly preferably z≧0.5.

31. The battery cell according to claim 25, wherein in the process of producing the electrodes after the removal of the solvent a layer which contains metallic lithium has been applied to or introduced into the negative electrode and/or the positive electrode before the assembly of the battery cell.

32. A rechargeable non-aqueous electrochemical battery cell with
a negative electrode with an electronically conductive substrate, and
a sulfur dioxide-containing electrolyte and
a positive electrode,
wherein during the process of manufacturing an electrode the active material of the electrode is mixed with a solvent and then applied to or pasted into the discharge element of the electrode, and wherein the solvent is removed, and after the removal of the solvent a layer which contains metallic lithium has been applied to or introduced into the negative electrode and/or the positive electrode before the assembly of the battery cell.

33. A battery cell according to claim 32, wherein the layer which contains metallic lithium has been rolled into the electrode by means of a rolling process, wherein a polymeric film as separating agent is guided between the lithium and the roller.
